(19) United States
(12) Patent Application Publication
(10) Pub. No.: US 2018/0001341 A1
(43) Pub. Date: Jan. 4, 2018

(54) Structure Body and Pattern Formation Method

(71) Applicant: Kabushiki Kaisha Toshiba, Tokyo (JP)

(72) Inventors: Tomoaki SAWABE, Tokyo (JP); Akira WATANABE, Kawasaki (JP); Naoko KlHARA, Kawasaki (JP); Ryosuke YAMAMOTO, Kawasaki (JP)

(73) Assignee: Kabushiki Kaisha Toshiba, Tokyo (JP)

(21) Appl. No.: 15/435,484

(22) Filed: Feb. 17, 2017

(30) Foreign Application Priority Data
Jul. 1, 2016 (JP) 2016-131484

(51) Int. Cl. B05D 1/32

(52) U.S. Cl. CPC B05D 1/32

(57) ABSTRACT

According to one embodiment, a structure body includes a plurality of particles and a base body. The particles are separated from each other. The each of the particles includes a first polymer provided at an outer surface of the each of the particles. The base body includes a surface having a protrusion and a recess. The base body includes a second polymer provided at the surface. The second polymer is different from the first polymer. The particles are supported by the protrusion, and the particles are separated from the recess.

### CROSS REFERENCE TO RELATED APPLICATIONS

This application is based upon and claims the benefit of priority from Japanese Patent Application No. 2016-131484, filed on Jul. 1, 2016; the entire contents of which are incorporated herein by reference.

### FIELD

Embodiments described herein relate generally to a structure body and a pattern formation method.

### BACKGROUND

For example, there is a structure body in which multiple particles are arranged in contact with each other. It is difficult to arrange the multiple particles to be separated from each other. It is difficult to control the arrangement directions of the multiple particles.

### BRIEF DESCRIPTION OF THE DRAWINGS

FIG. 1A to FIG. 1D are schematic views illustrating a structure body according to a first embodiment;

FIG. 2A to FIG. 2C are schematic cross-sectional views illustrating the method for manufacturing the structure body according to the first embodiment;

FIG. 3A to FIG. 3D are schematic views showing an experiment relating to the structure body;

FIG. 4A and FIG. 4B are schematic views illustrating the contact angles;

FIG. 5 is a schematic plan view illustrating another structure body according to the first embodiment;

FIG. 6 is a schematic plan view illustrating another structure body according to the first embodiment;

FIG. 7 is a schematic plan view illustrating another structure body according to the first embodiment;

FIG. 8 is a schematic plan view illustrating another structure body according to the first embodiment;

FIG. 9 is a schematic plan view illustrating another structure body according to the first embodiment;

FIG. 10A to FIG. 10D are schematic views showing the experiment relating to the structure body;

FIG. 11 is a flowchart illustrating a pattern formation method according to a second embodiment; and

FIG. 12A to FIG. 12F are schematic cross-sectional views in order of the processes, illustrating the pattern formation method according to the second embodiment.

### DETAILED DESCRIPTION

According to one embodiment, a structure body includes a plurality of particles and a base body. The particles are separated from each other. The each of the particles includes a first polymer provided at an outer surface of the each of the particles. The base body includes a surface having a protrusion and a recess. The base body includes a second polymer provided at the surface. The second polymer is different from the first polymer. The particles are supported by the protrusion, and the particles are separated from the recess.

According to another embodiment, a pattern formation method can include a solution film formation process of forming a solution film on a surface of a base body. The solution film includes a liquid and a plurality of particles. The surface has a protrusion and a recess. Each of the particles includes a first polymer provided at an outer surface of the particle. The base body includes a second polymer provided at the surface. The second polymer is different from the first polymer. The method can include a liquid removal process of removing the liquid. After the removing of the liquid, the particles are supported by the protrusion, and the particles are separated from the recess.

Various embodiments will be described hereinafter with reference to the accompanying drawings.

The drawings are schematic and conceptual; and the relationships between the thickness and width of portions, the proportions of sizes among portions, etc., are not necessarily the same as the actual values thereof. Further, the dimensions and proportions may be illustrated differently among drawings, even for identical portions.

In the specification and drawings, components similar to those described or illustrated in a drawing thereinabove are marked with like reference numerals, and a detailed description is omitted as appropriate.

### First Embodiment

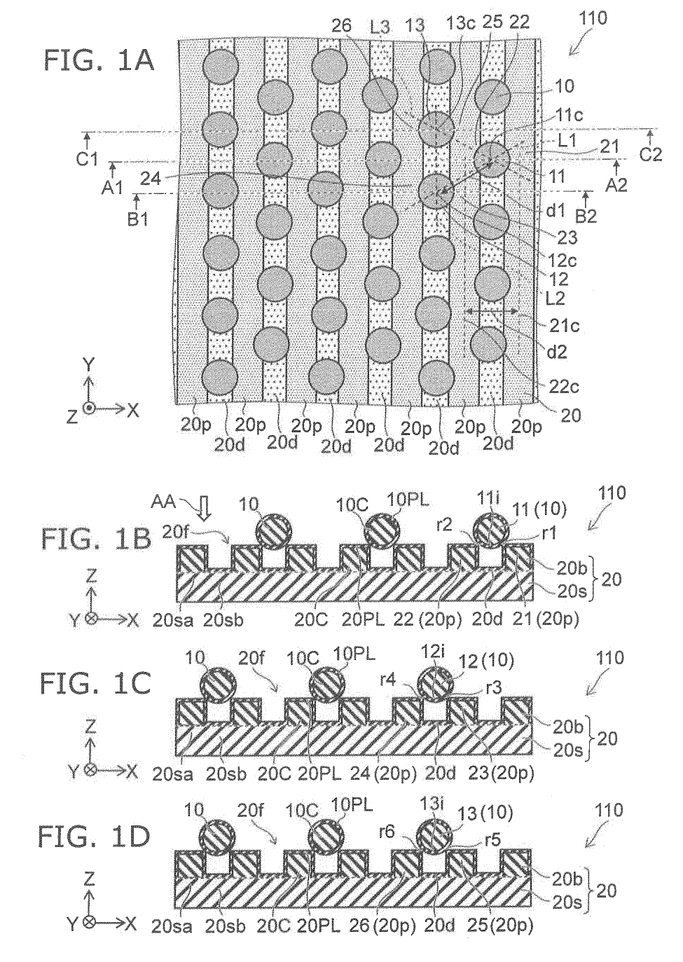

FIG. 1A to FIG. 1D are schematic views illustrating a structure body according to a first embodiment.

FIG. 1A is a plan view as viewed along arrow AA of FIG. 1B. FIG. 1B is a line A1-A2 cross-sectional view of FIG. 1A. FIG. 1C is a line B1-B2 cross-sectional view of FIG. 1A. FIG. 1D is a line C1-C2 cross-sectional view of FIG. 1A.

As shown in FIG. 1A to FIG. 1D, the structure body 110 according to the embodiment includes multiple particles 10 and a base body 20.

The multiple particles 10 are separated from each other. Each of the multiple particles 10 includes a first polymer 10PL. The first polymer 10PL is not illustrated in FIG. 1A. The first polymer 10PL is provided at the outer surface of the particle 10.

In the example, each of the multiple particles 10 further includes a core 10C (referring to FIG. 1B to FIG. 1D). The first polymer 10FL is provided around the core 10C. For example, the first polymer 10PL is bonded to the outer surface of the core 10C, For example, the bond is by graft polymerization. For example, the cores 10C are arranged to be separated from each other by the first polymers 10PL.

The core 10C includes, for example, silica (silicon oxide). The first polymer 10PL includes, for example, PMMA (Polymethyl methacrylate). Other examples of these materials are described below.

The multiple particles 10 are arranged along a first plane. The first plane is, for example, the X-Y plane. One direction in the X-Y plane is taken as an X-axis direction. A direction parallel to the X-Y plane and perpendicular to the X-axis direction is taken as a Y-axis direction. A direction perpendicular to the X-Y plane is taken as a Z-axis direction.

The base body 20 has a surface 20f. The surface 20f is, for example, the upper surface. The surface 20f spreads along the X-Y plane.

The surface 20f has a protrusion 20p and a recess 20d.

In the example, the protrusion 20p is provided in multiple band configurations. For example, the recess 20d may be provided in multiple band configurations. For example, the ends of the multiple protrusions 20p may be connected to each other. For example, the ends of the multiple recesses 20d may be connected to each other.

In the example, the protrusion 20p and the recess 20d extend along the Y-axis direction.

The base body 20 includes a second polymer 20PL. The second polymer 20PL is provided at the surface 20f. The second polymer 20PL is different from the first polymer 10PL. For example, in the case where the first polymer 10PL includes PMMA, the second polymer 20PL includes PS (polystyrene). Other examples of the second polymer 20PL are described below.

In the example, the base body 20 includes a substrate 20s and a structure member 20b. The substrate 20s includes a first partial region 20sa and a second partial region 20sb. The second partial region 20sb is used to form the recess 20d recited above. The second partial region 20sb is arranged with the first partial region 20sa in a direction aligned with the surface 20f. The substrate 20s includes a first base body material. The first base body material is, for example, silicon.

The structure member 20b is provided on the second partial region 20sb. The structure member 20b is used to form the protrusion 20p. For example, the structure member 20b includes a second base body material. For example, the second base body material may be different from the first base body material. In the case where the first substrate material includes silicon, the second base body material may include, for example, carbon.

In the embodiment, the material of the substrate 20s may be the same as the material of the structure member 20b. In such a case, the base body 20 is one body. In the case where the base body 20 includes a base body core 20C, the second polymer 20PL is provided on the base body core 20C. For example, the second polymer 20PL covers the base body core 20C.

As shown in FIG. 1B to FIG. 1D, the multiple particles 10 are supported by the protrusion 20p of the base body 20. The multiple particles 10 are separated from the recess 20d of the base body 20.

Three particles 10 that are included in the multiple particles 10 will now be focused upon. The multiple particles 10 include first to third particles 11 to 13.

As shown in FIG. 1B, the first particle 11 includes a first side region r1, a second side region r2, and a first middle region 11i. The first side region r1 is supported by a first protrusion region 21 of the protrusion 20p. The second side region r2 is supported by a second protrusion region 22 of the protrusion 20p. The first middle region 11i is between the first side region r1 and the second side region r2 in a direction (e.g., a direction along the X-axis direction) from the first protrusion region 21 toward the second protrusion region 22. The first middle region 11i is separated from the recess 20d.

As shown in FIG. 1C, a second particle 12 includes a third side region r3, a fourth side region r4, and a second middle region 12i. The third side region r3 is supported by a third protrusion region 23 of the protrusion 20p. The fourth side region r4 is supported by a fourth protrusion region 24 of the protrusion 20p. The second middle region 12i is between the third side region r3 and the fourth side region r4 in the direction from the third protrusion region 23 toward the fourth protrusion region 24. The second middle region 12i is separated from the recess 20d.

As shown in FIG. 1D, the third particle 13 includes a fifth side region r5, a sixth side region r6, and a third middle region 13i. The fifth side region r5 is supported by a fifth protrusion region 25 of the protrusion 20p. The sixth side region r6 is supported by a sixth protrusion region 26 of the protrusion 20p. The third middle region 131 is between the fifth side region r5 and the sixth sloe region r6 in the direction from the fifth protrusion region 25 toward the sixth protrusion region 26. The third middle region 13i is separated from the recess 20d.

In the example, the third protrusion region 23 is continuous with the second protrusion region 22. The fifth protrusion region 25 is continuous with the second protrusion region 22. As described below, the multiple protrusion regions may be separated from each other.

The second particle 12 is most proximal to the first particle 11 among the multiple particles 10. The third particle 13 is most proximal to the second particle 12 among the multiple particles 10. The third particle 13 is most proximal to the first particle 11 among the multiple particles 10 excluding the second particle 12. These two particles 10 are most proximal to each other.

In the embodiment, for example, such three particles 10 are positioned substantially at vertices of an equilateral triangle.

For example, the first particle 11 has a center (a first particle center 11c) in the first plane (the X-Y plane). The second particle 12 has a center (a second particle center 12c) in the first plane. The third particle 13 has a center (a third particle center 13c) in the first plane. A first straight line L1 connects the first particle center 11c and the second particle center 12c. A second straight line L2 connects the second particle center 12c and the third particle center 13c. A third straight line 13 connects the third particle center 13c and the first particle center 11c.

The angle between the first straight line L1 and the second straight line L2 is substantially 60 degrees (e.g., not less than 57 degrees and not more than 63 degrees). The angle between the second straight line L2 and the third straight line L3 is substantially 60 degrees (e.g., not less than 57 degrees and not more than 63 degrees). The angle between the third straight line L3 and the first straight line L1 is substantially 60 degrees (e.g., not less than 57 degrees and not more than 63 degrees).

The other multiple particles 10 also have similar arrangements.

For example, the base body 20 can be patterned using the arranged multiple particles 10. For example, the multiple particles 10 are used as a mask. For example, the base body 20 includes a portion that does not overlap the multiple particles 10. The portion that does not overlap is removed by etching. Thus, in the structure body 110, the multiple particles 10 that are separated from each other are arranged. According to the embodiment, a structure body can be provided in which the multiple particles can be arranged to be separated from each other. According to the embodiment, for example, the arrangement directions of the multiple particles are controlled in a state in which the multiple particles are separated from each other.

In the example, the extension direction of the protrusion 20p (or the recess 20d) is tilted with respect to the most proximal direction between the multiple particles 10.

For example, the pitch of the multiple protrusions 20p is determined appropriately to correspond to the center-center distance between two most proximal multiple particles 10. For example, the center-center distance between the two most proximal multiple particles 10 is determined to correspond to the pitch of the multiple protrusions 20p.

For example, the first protrusion region 21 and the second protrusion region 22 extend along the first extension direction. In the example, the first extension direction is the Y-axis direction. Here, a first width direction is a direction (the X-axis direction) aligned with the first plane (the X-Y plane) and perpendicular to the first extension direction (the Y-axis direction).

The first protrusion region 21 has a center (a first protrusion region center 21c) in the first width direction (the X-axis direction). The second protrusion region 22 has a center (a second protrusion region center 22c) in the first width direction. A distance d2 along the first width direction between the first protrusion region center 21c and the second protrusion region center 22c corresponds to the pitch of the multiple protrusion regions.

On the other hand, a distance d1 between the first particle center 11c and the second particle center 12c corresponds to the pitch of the multiple particles 10. The distance d2 is about (3^{1/2})/2 times the distance d1. Considering the error, it is favorable for the distance d2 to be not less than 0.69 times and not more than 1.04 times the distance d1.

For example, the distance d2 is determined to match the desired value of the pitch (the distance d1) of the multiple particles.

An example of a method for manufacturing the structure body 110 according to the embodiment will now be described. The method for manufacturing the structure body corresponds to a pattern formation method. The manufacturing method (the pattern formation method) of the structure body includes, for example, an arrangement process of the multiple particles 10.

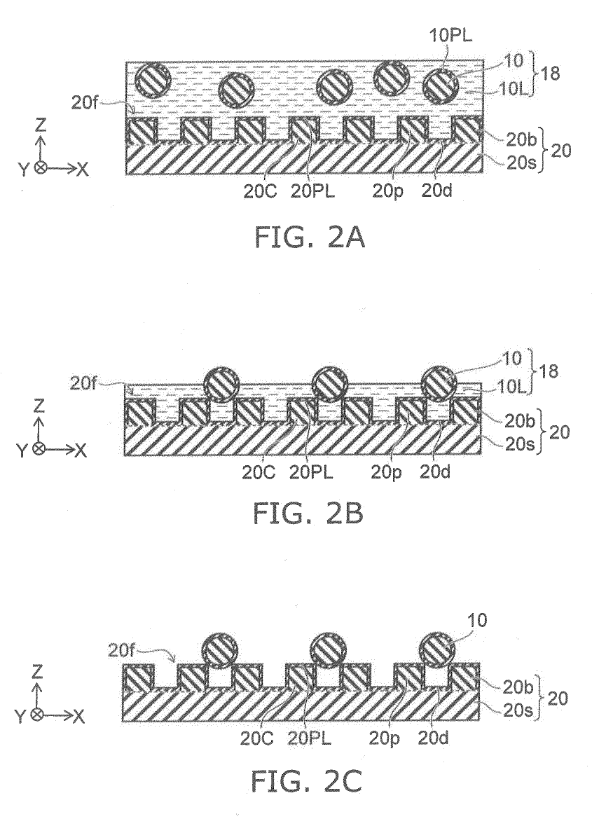

FIG. 2A to FIG. 2C are schematic cross-sectional views illustrating the method for manufacturing the structure body according to the first embodiment.

As shown in FIG. 2A, the manufacturing method (the pattern formation method) of the structure body includes a solution film formation process. In the solution film formation process, a solution film 18 is formed on the surface 20f of the base body 20. The solution film 18 includes a liquid 10L and the multiple particles 10. For example, the solution film 18 is formed by coating. The surface 20f of the base body 20 has the protrusion 20p and the recess 20d. Each of the multiple particles 10 includes the first polymer 10PL provided at the outer surface of the particle 10. The base body 20 includes the second polymer 20PL provided at the surface 20f. The second polymer 20PL is different from the first polymer 10PL.

The liquid 10L includes, for example, an organic solvent. The organic solvent may include, for example, at least one of toluene, methyl ethyl ketone (MEK), methyl butyl ketone (MBK), propylene glycol monomethyl ether acetate (PGMEA), or methoxybenzene. The liquid 10L may include water (e.g., purified water, etc.). The liquid 10L is selected from a liquid in which the multiple particles 10 are dispersed. The multiple particles 10 are substantially separated from each other inside the liquid 10L in the state in which the multiple particles 10 are dispersed. The liquid 10L may include a solvent in which the first polymer 10PL of the multiple particles 10 is dissolved.

Subsequently, the liquid 10L decreases as shown in FIG. 2B. For example, the decrease is caused by vaporization of the liquid 10L, etc. Further, the liquid 10L substantially disappears as shown in FIG. 2C. In other words, the manufacturing method (the pattern formation method) of the structure body includes a liquid removal process of removing the liquid 10L. In the liquid removal process, for example, the base body 20 and the multiple particles 10 may be in a reduced-pressure state. In the liquid removal process, for example, the base body 20 and the multiple particles 10 may be heated. These may be implemented in combination. In the liquid removal process, for example, the base body 20 and the multiple particles 10 may be left idle. The liquid 10L is discharged efficiently via the recess 20d.

Such a solution film formation process and such a liquid removal process are included in an arrangement process.

After removing the liquid 10L, the multiple particles 10 are separated from each other. The multiple particles 10 are supported by the protrusion 20p; and the multiple particles 10 are separated from the recess 20d. For example, the state described in reference to FIG. 1A to FIG. 1D is obtained.

In the manufacturing method (the pattern formation method) recited above, due to the capillary force of the liquid 10L, the multiple particles 10 are arranged at the prescribed positions while being separated from each other when removing the liquid 10L. It was found that such a phenomenon occurs when the second polymer 20PL of the front surface of the base body 20 is different from the first polymer 10PL of the outer surface of the multiple particles 10.

An example of an experiment performed by the inventor will now be described.

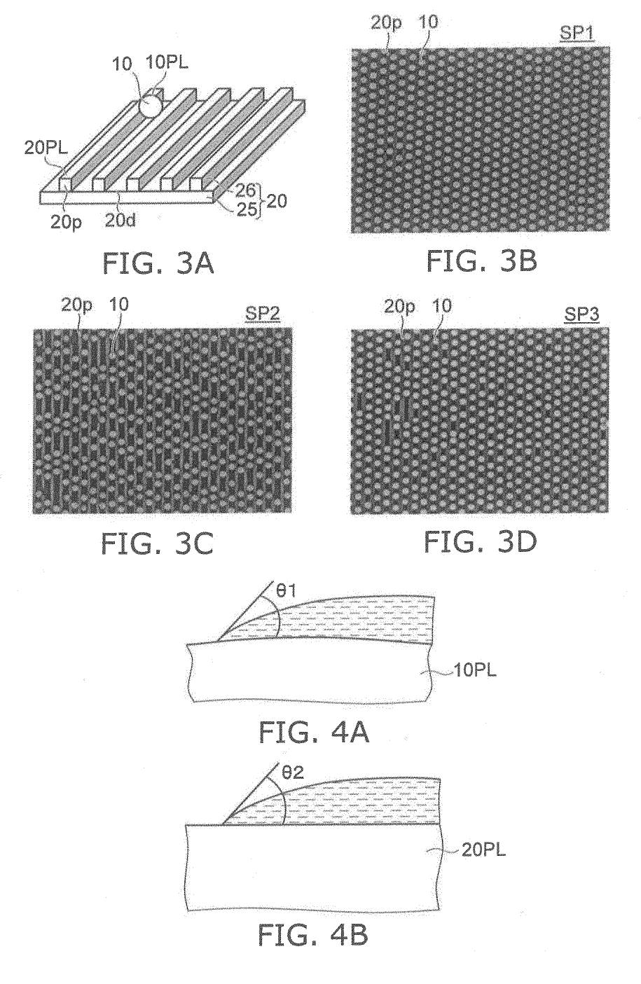

FIG. 3A to FIG. 3D are schematic views showing an experiment relating to the structure body.

FIG. 3A is a perspective view illustrating the base body 20 used in the experiment. FIG. 3B to FIG. 3D are electron micrographs showing the experimental results.

As shown in FIG. 3A, the substrate 20s and the structure member 20b are provided in the base body 20. The upper surface of the substrate 20s corresponds to the recess 20d. The structure member 20b corresponds to the protrusion 20p. The structure member 20b has a band configuration. In the experiment, the substrate 20s is a silicon substrate. The structure member 20b includes a carbon film, and a silicon film provided on the carbon film. A film of the second polymer 20PL is provided on such a substrate 20s and such a structure member 20b. The material that is used to form the second polymer 20PL includes, for example, an OH group at the polymer terminal. Heating or the like is performed after forming the film of the second polymer 20PL. The second polymer 20PL is bonded to the front surface of the substrate 20s. For example, the bond is by graft polymerization. The solution film 18 that includes the multiple particles 10 is formed on the second polymer 20PL. The liquid 10L includes, for example, MEK. The concentration of the multiple particles 10 in the solution film 18 is about 2 wt %.

In the experiment, the core 10C of the particle 10 is silica. The first polymer 10PL is PMMA. In a first sample SP1, the second polymer 20PL is PS. In a second sample SP2, the second polymer 20PL is not provided. In the second sample SP2, the silicon of the substrate 20s and the silicon of the upper portion of the structure member 20b are exposed at the surface 20f of the base body 20. In a third sample SP3, the second polymer 20PL is PMMA. In other words, in the third sample SP3, the second polymer 20PL is the same as the first polymer 10PL.

As shown in FIG. 3B, a good arrangement of the multiple particles 10 is obtained in the first sample SP1.

As shown in FIG. 3C and FIG. 3D, the orderliness of the multiple particles 10 is poor in the second sample SP2 and the third sample SP3.

For example, a long chain group that is bonded to the outer surface of the multiple particles 10 is provided in the first polymer 10PL. A long chain group that is bonded to the front surface of the substrate 20s is provided in the second polymer 20PL. In one particle 10, multiple long chain groups extend outward from the core 10C at the center. In the first sample SP1, the type of the long chain group of the first polymer 10PL and the type of the long chain group of the second polymer 20PL are different from each other; therefore, these long chain groups repel each other. Therefore, the multiple particles 10 and the substrate 20s repel each other in the state in which the liquid 10L exists around the multiple particles 10; and the distance between the multiple particles 10 is maintained moderately by the first polymer 10PL. Thereby, it is considered that the self assembly of the multiple particles 10 is promoted by the capillary force of the liquid 10L.

On the other hand, in the third sample SP3, the type of the long chain group of the first polymer 10PL is the same as the type of the long chain group of the second polymer 20PL. Therefore, the multiple particles 10 easily adhere to the second polymer 20PL of the base body 20 in the state in which the liquid 10L exists around the multiple particles 10. The multiple particles 10 adhere to the front surface of the base body 20 before the self assembly due to the capillary force of the liquid 10L. Therefore, it is considered that the arrangement by self assembly is not obtained sufficiently; and the orderliness of the multiple particles 10 is poor.

The second polymer 20PL is not provided in the second sample SP2. Therefore, the multiple particles 10 easily adhere to the front surface of the base body 20 in the state in which the liquid 10L exists around the multiple particles 10. The multiple particles 10 adhere to the front surface of the base body 20 before the self assembly due to the capillary force of the liquid 10L. Therefore, in such a case as well, it is considered that the arrangement by self assembly is not obtained sufficiently; and the orderliness of the multiple particles 10 is poor.

Thus, good orderliness is obtained by setting the first polymer 10PL and the second polymer 20PL to be different from each other. The precision of the pitch of the multiple particles 10 increases.

For example, the diameter of the multiple particles 10 is, for example, not less than 5 nm and not more than 500 nm. The thickness of the first polymer 10PL is, for example, not less than 1 nm and not more than 500 nm. The height of the protrusion 20p of the base body 20 is, for example, not less than 5 nm and not more than 500 nm. The thickness of the second polymer 20PL is, for example, not less than 1 nm and not more than 500 nm.

In the embodiment, the first polymer 10PL includes one selected from the group consisting of polystyrene, polybutadiene, polyethylene, polymethyl methacrylate sodium polyacrylate, polyethylene oxide, polymethyl acrylate, polyvinylpyridine, polydimethyl siloxane, polyacrylic acid, polymethacrylic acid, polydimethyl acryl, and polybutyl methacrylate. On the other hand, the second polymer 20PL includes one other selected from the group recited above.

For example, the first polymer 10PL includes a benzene ring; and the second polymer 20PL includes an ester bond.

The contact angles of the first polymer 10PL and the second polymer 20PL may be different from each other.

FIG. 4A and FIG. 4B are schematic views illustrating the contact angles.

FIG. 4A shows a contact angle θ1 of the first polymer 10PL. FIG. 4B shows a contact angle θ2 of the second polymer 20PL.

Because the first polymer 10PL is provided at the outer surface of the particle 10, there are many cases where the outer surface of the first polymer 10PL is not flat. The contact angle of a polymer surface of the same material as the first polymer 10PL may be used as the contact angle θ1 of the first polymer 10PL.

The second polymer 20PL is provided at the recess 20d and the protrusion 20p of the base body 20. In the case where there is an unevenness, it may be difficult to evaluate the second polymer 20PL. The contact angle of a polymer surface of the same material as the second polymer 20PL may be used as the contact angle θ2 of the second polymer 20PL.

In the embodiment, for example, the contact angle θ1 of the first polymer 10PL with water is greater than 90 degrees; and the contact angle θ2 of the second polymer 20PL with water is less than 90 degrees.

In the embodiment, the contact angle θ1 of the first polymer 10PL with water may be less than 90 degrees; and the contact angle θ2 of the second polymer 20PL with water may be greater than 90 degrees.

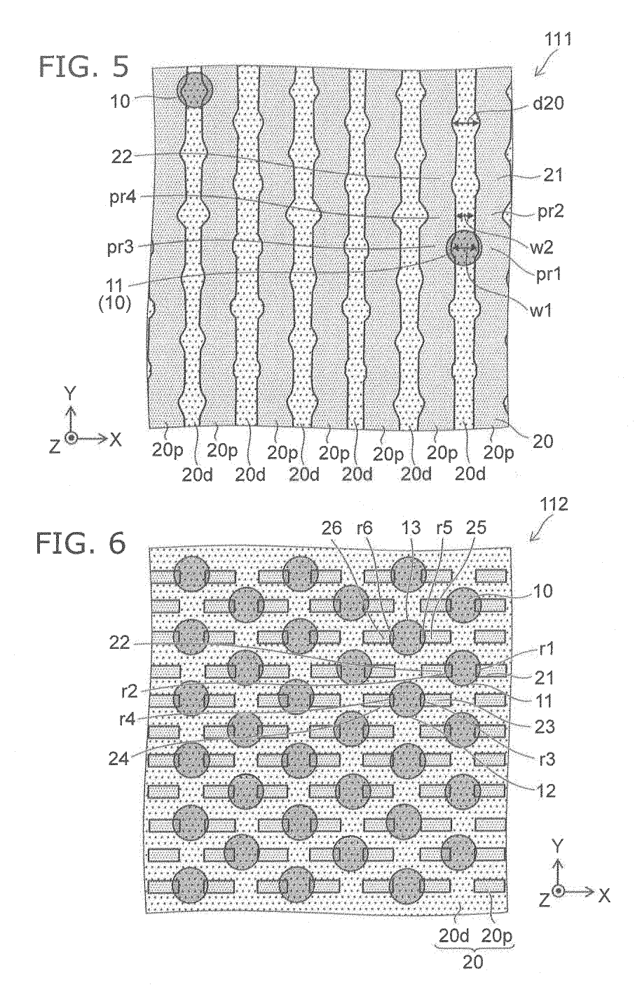

FIG. 5 is a schematic plan view illustrating another structure body according to the first embodiment.

In FIG. 5, two of the multiple particles 10 are drawn for easier viewing of the drawing.

As shown in FIG. 5, the other structure body 111 according to the embodiment also includes the base body 20 and the multiple particles 10. In the example, the protrusion 20p of the base body 20 has a band configuration; and the width of the band changes. Otherwise, the structure body 111 is similar to the structure body 111.

In the structure body 111, a distance d20 along the first width direction (the X-axis direction) between the first protrusion region 21 and the second protrusion region 22 changes periodically in the first extension direction (the Y-axis direction). The particle 10 is provided at the portion where the width (the distance d20) is large.

For example, the first protrusion region 21 includes a first protrusion partial region pr1 and a second protrusion partial region pr2. The second protrusion partial region pr2 is arranged with the first protrusion partial region pr1 in the first extension direction (the Y-axis direction).

On the other hand, the second protrusion region 22 includes a third protrusion partial region pr3 and a fourth protrusion partial region pr4. The third protrusion partial region pr3 overlaps the first protrusion partial region pr1 in the first width direction (the X-axis direction). The fourth protrusion partial region pr4 is arranged with the third protrusion partial region pr3 in the first extension direction (the Y-axis direction). The fourth protrusion partial region pr4 overlaps the second protrusion partial region pr2 in the first width direction (the X-axis direction).

A distance w1 along the first width direction (the X-axis direction) between the first protrusion partial region pr1 and the third protrusion partial region pr3 is longer than a distance w2 along the first width direction between the second protrusion partial region pr2 and the fourth protrusion partial region pr4.

The first particle 11 is supported by the first protrusion partial region pr1 and the third protrusion partial region pr3. The second protrusion partial region pr2 and the fourth protrusion partial region pr4 do not overlap the multiple particles 10 in the Z-axis direction. The Z-axis direction is a direction perpendicular to the first plane (the X-Y plane).

For example, the first protrusion partial region pr1 and the third protrusion partial region pr3 are portions of the protrusion 20p where the width is narrow. The multiple particles 10 may be disposed selectively at such portions.

FIG. 6 is a schematic plan view illustrating another structure body according to the first embodiment.

As shown in FIG. 6, the other structure body 112 according to the embodiment also includes the base body 20 and the multiple particles 10. In the example, the protrusion 20p of the base body 20 has an island configuration. Otherwise, the structure body 112 is similar to the structure body 110.

In the structure body 112 as well, the first to sixth protrusion regions 21 to 26 are provided in the base body 20. At least a portion of these protrusion regions is mutually-discontinuous.

For example, the first particle 11 is supported by the first protrusion region 21 and the second protrusion region 22. The second particle 12 is supported by the third protrusion region 23 and the fourth protrusion region 24. The third particle 13 is supported by the fifth protrusion region 25 and the sixth protrusion region 26.

A portion of the recess 20d may be positioned in at least one space between the third protrusion region 23 and the first protrusion region 21, between the fourth protrusion region 24 and the first protrusion region 21, between the third protrusion region 23 and the second protrusion region 22, or between the fourth protrusion region 24 and the second protrusion region 22.

A portion of the recess 20d may be positioned in at least one space between the fifth protrusion region 25 and the first protrusion region 21, between the sixth protrusion region 26 and the first protrusion region 21, between the fifth protrusion region 25 and the second protrusion region 22, or between the sixth protrusion region 26 and the second protrusion region 22.

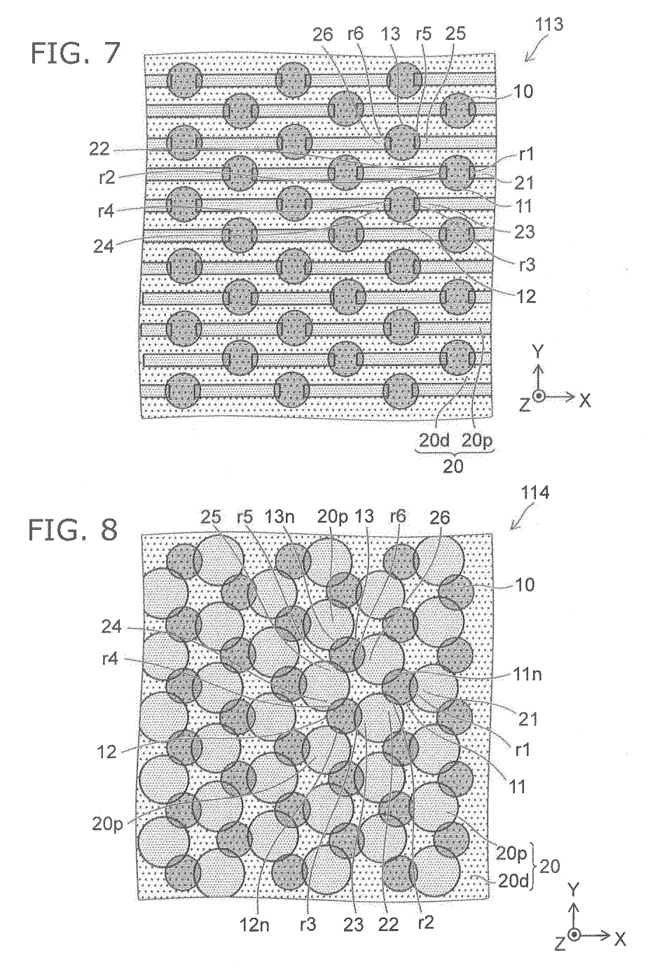

FIG. 7 is a schematic plan view illustrating another structure body according to the first embodiment.

As shown in FIG. 7, the other structure body 113 according to the embodiment also includes the base body 20 and the multiple particles 10. In the example as well, the protrusion 20p of the base body 20 has an island configuration. The protrusion 20p extends in the X-axis direction. One of the multiple particles 10 is supported by the multiple protrusions 20p arranged in the X-axis direction. Otherwise, the structure body 113 is similar to the structure body 110.

FIG. 8 is a schematic plan view illustrating another structure body according to the first embodiment.

As shown in FIG. 8, the other structure body 114 according to the embodiment also includes the base body 20 and the multiple particles 10. In the example as well, the protrusion 20p of the base body 20 has an island configuration. The center of the protrusion 20p is positioned at the position of the center of three particles 10. In the example, one particle 10 is supported by three protrusions 20p. For example, the first particle 11 is supported by the three regions of the first side region r1, the second side region r2, and a side region 11n. For example, the second particle 12 is supported by the three regions of the third side region r3, the fourth side region r4, and a side region 12n. For example, the third particle 13 is supported by the three regions of the fifth side region r5, the sixth side region r6, and a side region 13n. Otherwise, the structure body 114 is similar to the structure body 110.

In the structure bodies 111 to 114 as well, the multiple particles 10 can be arranged to be separated from each other. Good orderliness of the multiple particles 10 is obtained. In these examples as well, for example, the arrangement directions of the multiple particles are controlled in the state in which the multiple particles are separated from each other.

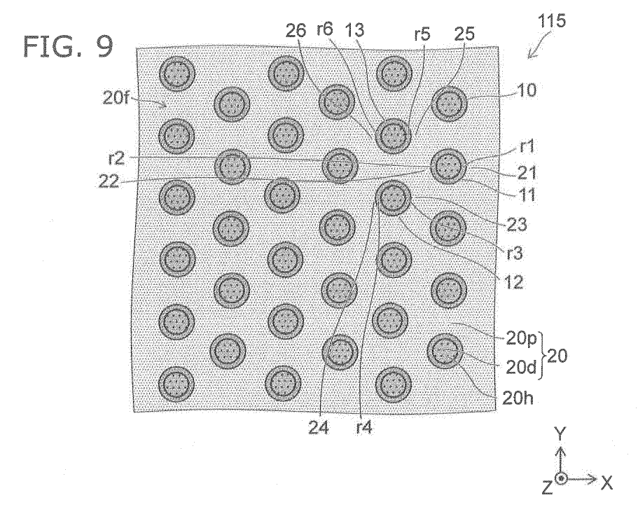

FIG. 9 is a schematic plan view illustrating another structure body according to the first embodiment.

As shown in FIG. 9, the other structure body 115 according to the embodiment also includes the base body 20 and the multiple particles 10. In the example, a hole 20h is provided in the base body 20. Otherwise, the structure body 115 is similar to the structure body 110.

In the structure body 115, the base body 20 has multiple holes 20h. The multiple holes 20b are provided in the surface 20f. The multiple holes 20h are used to form the recess 20d.

The particles 10 are supported by the protrusion 20p around the holes 20h. For example, the first particle 11 is supported by the first protrusion region 21 and the second protrusion region 22. One of the multiple holes 20h is positioned between the first protrusion region 21 and the second protrusion region 22.

An example of experimental results in the case where the holes 20h are provided in the base body 20 will now be described.

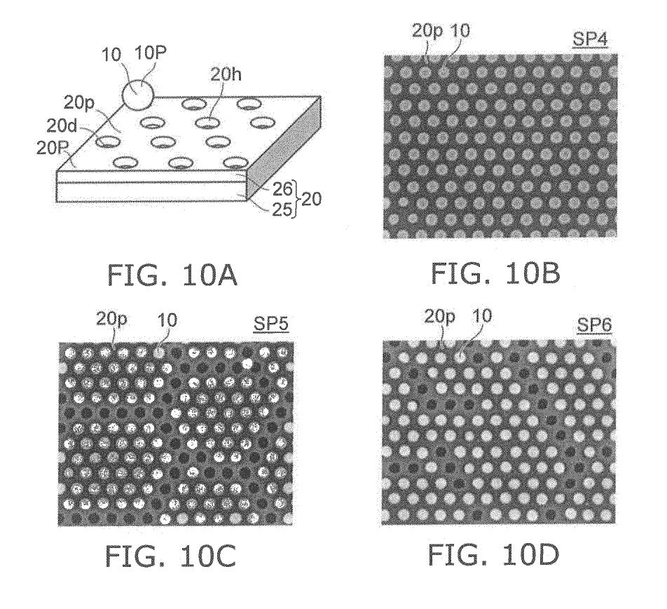

FIG. 10A to FIG. 10D are schematic views showing the experiment relating to the structure body.

FIG. 10A is a perspective view illustrating the base body 20 used in the experiment. FIG. 10B to FIG. 10D are electron micrographs showing the experimental results.

As shown in FIG. 10A, the multiple holes 20h are provided in the base body 20. The base body 20 includes the substrate 20s and the structure member 20b. The holes 20h pierce the structure member 20b. The substrate 20s is a silicon substrate. The structure member 20b includes a carbon film, and a silicon film provided on the carbon film. A film of the second polymer 20PL is provided on such a substrate 20s and such a structure member 20b. The solution film 18 that includes the multiple particles 10 is formed on the film of the second polymer 20PL. The material of the liquid 10L and the concentration of the multiple particles 10 are similar to those described in reference to FIG. 3A to FIG. 3D.

In the experiment as well, the core 10C of the particle 10 is silica. The first polymer 10PL is PMMA. In a fourth sample SP4, the second polymer 20PL is PS. In a fifth sample SP5, the second polymer 20PL is not provided. In a sixth sample SP6, the second polymer 20PL is PMMA.

As shown in FIG. 10B, a good arrangement of the multiple particles 10 is obtained in the fourth sample SP4.

As shown in FIG. 10C and FIG. 10D, the orderliness of the multiple particles 10 is poor in the fifth sample SP5 and the sixth sample SP6.

Thus, even in the case where the holes 20h are provided in the base body 20, good orderliness is obtained by setting the first polymer 10PL and the second polymer 20PL to be different from each other. The precision of the pitch of the multiple particles 10 increases.

In the structure body 115 as well, the multiple particles 10 can be arranged to be separated from each other. Good orderliness of the multiple particles 10 is obtained. According to the embodiment, for example, the arrangement directions of the multiple particles are controlled in the state in which the multiple particles are separated from each other.

### Second Embodiment

The embodiment relates to a pattern formation method. A portion of the pattern formation method corresponds to the method for manufacturing the structure body.

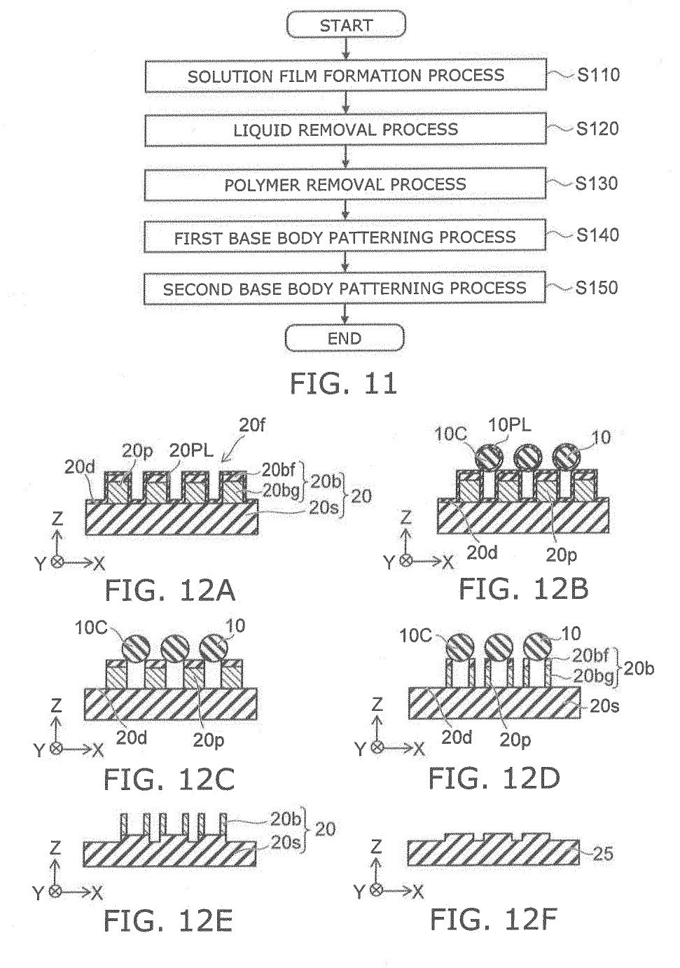

FIG. 11 is a flowchart illustrating the pattern formation method according to the second embodiment.

As shown in FIG. 11, the pattern formation method includes the solution film formation process (step S110) and the liquid removal process (step S120). The pattern formation method may further include step S130 to step S150 described below.

In the solution film formation process, the solution film 18 that includes the liquid 10L and the multiple particles 10 is formed on the surface 20f of the base body 20 (referring to FIG. 2A). The surface 20f of the base body 20 includes the protrusion 20p and the recess 20d. Each of the multiple particles 10 includes the first polymer 10PL provided at the outer surface of the particle 10. The base body 20 includes the second polymer 20PL that is different from the first polymer 10PL and is provided at the surface 20f. As described above, for example, the solution film formation process includes coating the solution including the liquid 10L and the multiple particles 10 on the surface 20f.

The liquid 10L includes, for example, an organic solvent. The organic solvent may include, for example, at least one of toluene, methyl ethyl ketone (MEK), methyl butyl ketone (MBK), propylene glycol monomethyl ether acetate (PGMEA), or methoxybenzene. The liquid 10L may include water (e.g., purified water, etc.). The liquid 10L is selected from a liquid in which the multiple particles 10 are dispersed. The multiple particles 10 are substantially separated from each other inside the liquid 10L in the state in which the multiple particles 10 are dispersed. The liquid 10L may include a solvent in which the first polymer 10PL of the multiple particles 10 is dissolved.

In the liquid removal process, the liquid 10L is removed (referring to FIG. 2B and FIG. 2C). After removing the liquid 10L, the multiple particles 10 are supported by the protrusion 20p; and the multiple particles 10 are separated from the recess 20d (referring to FIG. 1A to FIG. 1D).

FIG. 12A to FIG. 12F are schematic cross-sectional views in order of the processes, illustrating the pattern formation method according to the second embodiment.

The base body 20 is prepared as shown in FIG. 12A. For example, the structure member 20b is provided on the substrate 20s. The structure member 20b may include a first film 20bf and a second film 20bg. The second film 20bg is provided between the first film 20bf and the substrate 20s. The substrate 20s is, for example, a silicon substrate. The second film 20bg is, for example, a carbon film. The first film 20bf is a silicon film. The protrusion 20p and the recess 20d are formed of the substrate 20s and the structure member 20b.

The pattern formation method according to the embodiment may include a formation process of the base body 20. For example, the pattern formation method may include an unevenness formation process. The unevenness formation process forms the protrusion 20p and the recess 20d. For example, the formation of the protrusion 20p and the recess 20d may be implemented by a method including imprinting.

The multiple particles 10 are arranged as shown in FIG. 12B. In this process, the solution film formation process and the liquid removal process recited above are implemented.

Subsequently, a polymer removal process (step S130 shown in FIG. 11) is further implemented. In the polymer removal process as shown in FIG. 12C, the first polymer 10PL and the second polymer 20PL are removed after the liquid removal process recited above. For example, processing by a gas including oxygen or the like is performed. The processing includes at least one of RIE (Reactive Ion Etching) or UV ozone treatment.

For example, each of the multiple particles 10 includes the core 10C. The first polymer 10PL is provided around the core 10C. At least a portion of the core 10C remains after the polymer removal process recited above.

For example, the etching rate of the core 10C for the etchant (e.g., a gas including oxygen) used in the polymer removal process is lower than the etching rate of the first polymer 10PL for the etchant. For example, the etching rate of the core 10C for the etchant used in the polymer removal process is lower than the etching rate of the second polymer 20PL for the etchant. For example, the etching rate of the protrusion 20p for the etchant is lower than the etching rate of the second polymer 20PL for the etchant. The etching rate of the protrusion 20p for the etchant is lower than the etching rate of the first polymer 10PL for the etchant.

Subsequently, a first base body patterning process (step S140 shown in FIG. 11) is implemented. In the first base body patterning process as shown in FIG. 12D, a portion of the base body 20 is removed using the multiple particles 10 as a mask. The portion of the first film 20bf (the silicon film) not overlapping the particles is removed by, for example, processing using a gas including fluorocarbon (e.g., CF₄) by RIE, etc. Processing using a gas including oxygen is further performed. Thereby, the second film 20bg (the carbon film) that is exposed is removed by the removal of the first film 20bf.

Thus, the first base body patterning process includes removing a portion of the structure member 20b by using the multiple particles 10 as a mask.

Subsequently, the multiple particles 10 are removed as shown in FIG. 12E. For example, processing using a gas including a fluorocarbon (e.g., CF₄) is performed by RIE, etc. Thereby, the multiple particles 10 are removed. At this time, a portion of the substrate 20s (the silicon) may be removed.

Subsequently, a second base body patterning process (step S150 of FIG. 11) is implemented. For example, in the second base body patterning process as shown in FIG. 12F, the remaining portion of the structure member 20b is removed after the first base body patterning process. For example, processing using a gas including oxygen is performed.

By such a process, an uneven configuration that corresponds to the multiple particles 10 can be formed in the substrate 20s.

For example, the pattern formation method according to the embodiment is applicable to the manufacturing of a memory device such as a semiconductor memory device, etc. For example, the pattern formation method according to the embodiment is applicable to the formation of via electrodes, interconnects, etc. The pattern formation method according to the embodiment is applicable to the pattern formation of a nanoimprint mold, etc.

The embodiments may include the following configurations.

### (Configuration 1)

A structure body, comprising:

a plurality of particles separated from each other, each of the plurality of particles including a first polymer provided at an outer surface of the each of the plurality of particles; and

a base body including a surface having a protrusion and a recess, the base body including a second polymer provided at the surface, the second polymer being different from the first polymer,

the plurality of particles being supported by the protrusion, and the plurality of particles being separated from the recess.

### (Configuration 2)

The structure body according to configuration 1, wherein

the plurality of particles includes a first particle,

the first particle includes a first side region, a second side region, and a first middle region,

the first side region of the first particle is supported by a first protrusion region of the protrusion,

the second side region of the first particle is supported by a second protrusion region of the protrusion,

the first middle region is between the first side region and the second side region in a direction from the first protrusion region toward the second protrusion region, and

the first middle region is separated from the recess.

### (Configuration 3)

The structure body according to configuration 2, wherein

the plurality of particles is arranged along a first plane,

the plurality of particles further includes a second particle and a third particle,

the second particle is most proximal to the first particle among the plurality of particles,

the third particle is most proximal to the second particle among the plurality of particles, and the third particle is most proximal to the first particle among the plurality of particles excluding the second particle,

a first straight line connects a first particle center in the first plane of the first particle and a second particle center in the first plane of the second particle,

a second straight line connects the second particle center and a third particle center in the first plane of the third particle,

a third straight line connects the third particle center and the first particle center,

an angle between the first straight line and the second straight line is not less than 57 degrees and not more than 63 degrees,

an angle between the second straight line and the third straight line is not less than 57 degrees and not more than 63 degrees, and

an angle between the third straight line and the first straight line is not less than 57 degrees and not more than 63 degrees.

### (Configuration 4)

The structure body according to configuration 3, wherein

the first protrusion region and the second protrusion region extend along a first extension direction,

the first protrusion region has a first protrusion region center in a first width direction,

the second protrusion region has a second protrusion region center in the first width direction,

the first width direction is aligned with the first plane and perpendicular to the first extension direction, and

a distance along the first width direction between the first protrusion region center and the second protrusion region center is not less than 0.69 times and not more than 1.04 times a distance between the first particle center and the second particle center.

### (Configuration 5)

The structure body according to configuration 4, wherein a distance along the first width direction between the first protrusion region and the second protrusion region changes periodically in the first extension direction.

### (Configuration 6)

The structure body according to configuration 5, wherein

the first protrusion region includes:
a first protrusion partial region; and
a second protrusion partial region arranged with the first protrusion partial region in the first extension direction,

the second protrusion region includes:
a third protrusion partial region overlapping the first protrusion partial region in the first width direction; and
a fourth protrusion partial region overlapping the second protrusion partial region in the first width direction and being arranged with the third protrusion partial region in the first extension direction,

a distance along the first width direction between the first protrusion partial region and the third protrusion partial region is longer than a distance along the first width direction between the second protrusion partial region and the fourth protrusion partial region,

the first particle is supported by the first protrusion partial region and the third protrusion partial region, and

the second protrusion partial region and the fourth protrusion partial region do not overlap the plurality of particles in a direction perpendicular to the first plane,

### (Configuration 7)

The structure body according to configuration 3, wherein

the second particle includes a third side region, a fourth side region, and a second middle region,

the third side region is supported by a third protrusion region of the protrusion,

the fourth side region is supported by a fourth protrusion region of the protrusion,

the second middle region is between the third side region and the fourth side region in a direction from the third protrusion region toward the fourth protrusion region,

the second middle region is separated from the recess, and

a portion of the recess is positioned in at least one space between the third protrusion region and the first protrusion region, between the fourth protrusion region and the first protrusion region, between the third protrusion region and the second protrusion region, or between the fourth protrusion region and the second protrusion region.

### (Configuration 8)

The structure body according to configuration 2, wherein

the base body has a plurality of holes provided in the surface, the plurality of holes being used to form the recess, and

one of the plurality of holes is positioned between the first protrusion region and the second protrusion region.

### (Configuration 9)

The structure body according to one of configurations 1 to 8, wherein

a contact angle of the first polymer with water is greater than 90 degrees, and

a contact angle of the second polymer with water is less than 90 degrees.

### (Configuration 10)

The structure body according to one of configurations 1 to 8, wherein

a contact angle of the first polymer with water is less than 90 degrees, and

a contact angle of the second polymer with water is greater than 90 degrees.

### (Configuration 11)

The structure body according to one of configurations 1 to 10, wherein

the first polymer includes one selected from the group consisting of polystyrene, polybutadiene, polyethylene, polymethyl methacrylate sodium polyacrylate, polyethylene oxide, polymethyl acrylate, polyvinylpyridine, polydimethyl siloxane, polyacrylic acid, polymethacrylic acid, polydimethyl acryl, and polybutyl methacrylate, and

the second polymer includes one other selected from the group.

### (Configuration 12)

The structure body according to one of configurations 1 to 10, wherein

the first polymer includes a benzene ring, and

the second polymer includes an ester bond.

### (Configuration 13)

The structure body according to one of configurations 1 to 12, wherein

each of the plurality of particles further includes a core, and

the first polymer is provided around the core.

### (Configuration 14)

A pattern formation method, comprising:

a solution film formation process of forming a solution film on a surface of a base body, the solution film including a liquid and a plurality of particles, the surface having a protrusion and a recess, each of the plurality of particles including a first polymer provided at an outer surface of the particle, the base body including a second polymer provided at the surface, the second polymer being different from the first polymer; and

a liquid removal process of removing the liquid,

after the removing of the liquid, the plurality of particles being supported by the protrusion, and the plurality of particles being separated from the recess.

### (Configuration 15)

The method according to configuration 14, wherein the solution film formation process includes coating, on the surface, a solution including the liquid and the plurality of particles.

### (Configuration 16)

The method according to configuration 14 or 15, further comprising a polymer removal process of removing the first polymer and the second polymer after the liquid removal process.

### (Configuration 17)

The method according to configuration 16, wherein

each of the plurality of particles includes a core,

the first polymer is provided around the core, and

at least a portion of the core remains after the polymer removal process.

### (Configuration 18)

The method according to configuration 17, wherein an etching rate of the core for an etchant used in the polymer removal process is lower than an etching rate of the first polymer for the etchant.

### (Configuration 19)

The method according to configuration 18, further comprising a first base body patterning process of removing a portion of the base body by using the plurality of particles as a mask.

### (Configuration 20)

The method according to configuration 19, wherein

the base body includes:
a substrate including a first base body material, the substrate including a first partial region and a second partial region, the first partial region being used to form the recess; and
a structure member including a second base body material, the second base body material being different from the first base body material, the structure member being provided on the second partial region and used to form the protrusion, and

the first base body patterning process includes removing a portion of the structure member by using the plurality of particles as a mask.

### (Configuration 21)

The method according to configuration 20, further comprising a second base body patterning process of removing the remaining portion of the structure member after the first base body patterning process.

### (Configuration 22)

The method according to one of configurations 14 to 21, further comprising an unevenness formation process of forming the protrusion and the recess by imprinting.

### (Configuration 23)

The method according to one of configurations 14 to 22, wherein the liquid includes at least one selected from the group consisting of toluene, methyl ethyl ketone, methyl butyl ketone, propylene glycol monomethyl ether acetate, methoxybenzene, and water.

According to the embodiments, a structure body and a pattern formation method can be provided in which multiple particles can be arranged to be separated from each other.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in structure bodies such as particles, cores, first polymers, base bodies, substrates, structure members, second polymers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all structure bodies and pattern formation methods practicable by an appropriate design modification by one skilled in the art based on the structure bodies and pattern formation methods described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A structure body, comprising:
a plurality of particles separated from each other, each of the particles including a first polymer provided at an outer surface of the each of the particles; and
a base body including a surface having a protrusion and a recess, the base body including a second polymer provided at the surface, the second polymer being different from the first polymer,
the particles being supported by the protrusion, and the particles being separated from the recess.

2. The body according to claim 1, wherein
the particles include a first particle,
the first particle includes a first side region, a second side region, and a first middle region,
the first side region of the first particle is supported by a first protrusion region of the protrusion,
the second side region of the first particle is supported by a second protrusion region of the protrusion,
the first middle region is between the first side region and the second side region in a direction from the first protrusion region toward the second protrusion region, and
the first middle region is separated from the recess.

3. The body according to claim 2, wherein
the particles are arranged along a first plane,
the particles further include a second particle and a third particle,
the second particle is most proximal to the first particle among the particles,
the third particle is most proximal to the second particle among the particles, and the third particle is most proximal to the first particle among the particles excluding the second particle,
a first straight line connects a first particle center in the first plane of the first particle and a second particle center in the first plane of the second particle,
a second straight line connects the second particle center and a third particle center in the first plane of the third particle,
a third straight line connects the third particle center and the first particle center,
an angle between the first straight line and the second straight line is not less than 57 degrees and not more than 63 degrees,
an angle between the second straight line and the third straight line is not less than 57 degrees and not more than 63 degrees, and
an angle between the third straight line and the first straight line 1s not less than 57 degrees and not more than 63 degrees.

4. The body according to claim 3, wherein
the first protrusion region and the second protrusion region extend along a first extension direction,
the first protrusion region has a first protrusion region center in a first width direction,
the second protrusion region has a second protrusion region center in the first width direction,
the first width direction is aligned with the first plane and perpendicular to the first extension direction, and
a distance along the first width direction between the first protrusion region center and the second protrusion region center is not less than 0.69 times and not more than 1.04 times a distance between the first particle center and the second particle center.

5. The body according to claim 4, wherein a distance along the first width direction between the first protrusion region and the second protrusion region changes periodically in the first extension direction.

6. The body according to claim 5, wherein
the first protrusion region includes:
a first protrusion partial region; and
a second protrusion partial region arranged with the first protrusion partial region in the first extension direction,
the second protrusion region includes:
a third protrusion partial region overlapping the first protrusion partial region in the first width direction; and
a fourth protrusion partial region overlapping the second protrusion partial region in the first width direction and being arranged with the third protrusion partial region in the first extension direction,
a distance along the first width direction between the first protrusion partial region and the third protrusion partial region is longer than a distance along the first width direction between the second protrusion partial region and the fourth protrusion partial region,
the first particle is supported by the first protrusion partial region and the third protrusion partial region, and
the second protrusion partial region and the fourth protrusion partial region do not overlap the particles in a direction perpendicular to the first plane.

7. The body according to claim 3, wherein
the second particle includes a third side region, a fourth side region, and a second middle region,
the third side region is supported by a third protrusion region of the protrusion,
the fourth side region is supported by a fourth protrusion region of the protrusion,
the second middle region is between the third side region and the fourth side region in a direction from the third protrusion region toward the fourth protrusion region,
the second middle region is separated from the recess, and
a portion of the recess is positioned in at least one space between the third protrusion region and the first protrusion region, between the fourth protrusion region and the first protrusion region, between the third protrusion region and the second protrusion region, or between the fourth protrusion region and the second protrusion region.

8. The body according to claim 2, wherein
the base body has a plurality of holes provided in the surface, the holes being used to form the recess, and
one of the holes is positioned between the first protrusion region and the second protrusion region.

9. The body according to claim 1, wherein
a contact angle of the first polymer with water is greater than 90 degrees, and
a contact angle of the second polymer with water is less than 90 degrees.

10. The body according to claim 1, wherein
a contact angle of the first polymer with water is less than 90 degrees, and
a contact angle of the second polymer with water is greater than 90 degrees.

11. The body according to claim 1, wherein
the first polymer includes one selected from the group consisting of polystyrene, polybutadiene, polyethylene, polymethyl methacrylate sodium polyacrylate, polyethylene oxide, polymethyl acrylate, polyvinylpyridine, polydimethyl siloxane, polyacrylic acid, polymethacrylic acid, polydimethyl acryl, and polybutyl methacrylate, and
the second polymer includes one other selected from the group.

12. The body according to claim 1, wherein
the first polymer includes a benzene ring, and
the second polymer includes an ester bond.

13. The body according to claim 1, wherein
each of the particles further includes a core, and
the first polymer is provided around the core.

4. A pattern formation method, comprising:
a solution film formation process of forming a solution film on a surface of a base body, the solution film including a liquid and a plurality of particles, the surface having a protrusion and a recess, each of the particles including a first polymer provided at an outer surface of the particle, the base body including a second polymer provided at the surface, the second polymer being different from the first polymer; and
a liquid removal process of removing the liquid,
after the removing of the liquid, the particles being supported by the protrusion, and the particles being separated from the recess.

15. The method according to claim 14, wherein the solution film formation process includes coating, on the surface, a solution including the liquid and the particles.

16. The method according to claim 14, further comprising a polymer removal process of removing the first polymer and the second polymer after the liquid removal process.

17. The method according to claim 16, wherein
each of the particles includes a core,
the first polymer is provided around the core, and
at least a portion of the core remains after the polymer removal process.

18. The method according to claim 17, wherein an etching rate of the core for an etchant used in the polymer removal process is lower than an etching rate of the first polymer for the etchant.

19. The method according to claim 18, further comprising a first base body patterning process of removing a portion of the base body by using the particles as a mask.

20. The method according to claim 19, wherein
the base body includes:
a substrate including a first base body material, the substrate including a first partial region and a second partial region, the first partial region being used to form the recess; and
a structure member including a second base body material, the second base body material being different from the first base body material, the structure member being provided on the second partial region and used to form the protrusion, and
the first base body patterning process includes removing a portion of the structure member by using the particles as a mask.
